(19) United States
(12) Patent Application Publication
(10) Pub. No.: US 2014/0295372 A1
(43) Pub. Date: Oct. 2, 2014

(54) DEVICE OF COMPUTERIZED DENTAL MEASUREMENT AND MEASURING METHOD USABLE WITH SAID DEVICE

(71) Applicants: Mauricio HAENGGI, Buenos Aires (AR); Rafael HAENGGI, Entre Rios (AR)

(72) Inventors: Mauricio HAENGGI, Buenos Aires (AR); Rafael HAENGGI, Entre Rios (AR)

(21) Appl. No.: 14/143,432

(22) Filed: Dec. 30, 2013

(30) Foreign Application Priority Data
Mar. 27, 2013 (AR) 20130101035

(51) Int. Cl. A61C 19/04

(52) U.S. Cl. CPC A61C 19/04
USPC 433/72; 433/215

(57) ABSTRACT

This device comprises a measuring clamp (1) for teeth (20) and dental spaces (21), comprising a set of mobile arms (2) ending in some exploration extremities (3), which exploring displacement along the teeth (20) and dental spaces (21) determines the joint displacement of the mobile arms (2). A transducer (11) turns the relative displacement movement between mobile arms (2), into signals (25) expressing the positional parameters (23) determined by that movement, and, upon being connected to a computerized system (30), it transmits the signals (25) for their processing as measurement parameters (23). The transducer system (10), that may be analogue and/or digital, may have a manual driving means (12) in the measuring clamp (1). The invention is also related to a measuring method through which steps the exploration extremities (3) are arranged in the teeth (20) or dental spaces (21), the measurement is performed and the sequence is repeated, as many times as needed until completing the measurement. The measuring method comprises a series of steps through which the measuring clamp (1) is applied to the teeth (20) or dental spaces (21), the measurement is performed, it is confirmed that the measurement data (25) has entered the computerized system (30), and the form fields which sequentially appear available, repeating the corresponding steps, as many times as needed until completing the measurement.

### FIELD OF THE INVENTION

The present invention is related to the field of life current needs, in particular to the field of medical sciences and, within them, to measuring instruments especially conceived for dental technique.

More particularly, it consists of a device which enables the proper measurement of the teeth and dental spaces, by means of a measuring clamp provided from some exploration ends and a transducer, which signals may be managed by computerized systems. The invention is also related to a measuring method which enables to perform measurements in a proper manner, until completing all the required measurements.

### BACKGROUND OF THE INVENTION

Up to now, different measuring means are known. For example, KR20080082813A shows a bone meter comprising a measuring clamp with different variants, including measuring instruments that set the clamp opening.

U.S. Pat. No. 4,762,491 shows a dental measuring device based on an incision top, and a measuring arm tip related to a dial indicator and a protractor scale.

U.S. Pat. No. 5,176,516 shows another dental measuring device with jaws, elongated arms, scale and indicator display.

It is also known a contact digitizer device disclosed in U.S. Pat. No. 5,131,844.

Other measuring devices of the dental contour which operate connected to a computer are disclosed in U.S. Pat. No. 5,865,769, U.S. Pat. No. 7,014,461, and U.S. Pat. No. 5,957,868.

However, none of these devices known has a measuring clamp available, which mobile arms and exploration extremities are related to a transducer in order to generate signals that may be taken advantage by a computerized system.

### ADVANTAGES AND PURPOSES

An object of the present device is to enable the measurement of teeth and dental spaces, in conditions under which the position and the time to take each measurement may be chosen, as well as their records in computerized systems.

An advantage of the present device is that it is based on a measuring clamp that, in any of the variants considered, enables to position said clamp on the tooth or dental space, and by means of just pressing a push-button, to take the measure and send the information to a computerized system.

Another advantage is that it enables to establish a relation between the measurement performed and the degree of opening of the mobile arms, which is possible due to the presence of a transducer which turns the opening parameters into signals to be processed by any computerized system.

A further advantage is that, upon being connected to a computerized system, it may be also used with scheduled time intervals to carry out a series of measurements automatically.

A further advantage is to profit from the elastic means, under which influence the measurement clamp stays normally open, until the position looked for is reached, where it is pressed until the exploration extremities get to the tooth or dental space to be measured.

The present device, among other things, enables the following:
To measure the mesiodistal width of teeth, and to send the measurement to a computer, in order to obtain the results of the dental rates.
To measure spaces and distances between teeth.
To carry out measurements for implants.
To apply a bracket positioner according to the technique, prescription and tooth size.
To measure X-rays and set a scale to predict the size of non-erupted teeth.
Other dental measurements.
Etc.

### BRIEF DESCRIPTION OF THE DRAWINGS

For better clarity and understanding of the object of the invention, it is illustrated with several figures where it has been represented in one of its preferred embodiments, everything as an illustrative example, without limitation:

FIG. 1 is a perspective view of the present device, where it can be observed the measuring clamp applied to a tooth, as well as the transducer circuit connected to a USB port of computerized equipment.

FIG. 2 is an upper view, seen from above, of the present device, where its main component parts may be appreciated.

FIG. 3 is an upper view, seen from above, of the present device, in another embodiment where there is a part of wireless transmission.

In FIG. 4, they are: Drawing A, a side view, elevated, of the measuring clamp, in one of its embodiments.

Drawing B, a side view, elevated, of the measuring clamp in another embodiment, in which it has grip extremities, and with a push-button on the joint mobile connection.

Drawing C, a side views, elevated, of the measuring clamp in another embodiment where it has grip extremities, and with a push-button on one of said grip extremities.

In FIG. 5, they are:

Drawing A, a side view, elevated, of the measuring clamp in another embodiment in which elastic means is included.

Drawing B, a side view, elevated, of the measuring clamp in another embodiment where it has grip extremities and elastic means.

Drawing C, a side view, elevated, of the measuring clamp in another embodiment where it has a sliding mobile arm.

FIG. 6 is a schematic diagram which represents the transducer circuit in blocks, in one of its possible embodiments.

FIG. 7 is a schematic diagram which represents the measurement record driving and the transmission of the measurement signals, from the transducer to the computerized system.

FIG. 8 is a schematic representation in blocks which shows a possible embodiment of the transducer circuit, where it is indicated its analogue part and its digital part.

FIG. 9 is a schematic representation, by way of example, of the changes of form and screens where the measurement records performed are viewed.

In the different figures, the same numbers and/or reference letters indicate equal or corresponding parts.

### LIST OF THE MAIN REFERENCES

(1) Measuring clamp.
(2) Mobile arms.
(2a) Grip extremities.
(3) Exploration extremities.
(4) Mobile connection [between the mobile arms (2)].
(5) Elastic member.
(10) Transducer circuit.
(11) Transducer sensor.
(12) Driving push-button [driving means].
(13) Microcontroller.
(14) USB connector [connection means].
(15) First wiring.
(16) Second wiring.
(17) First wireless connection.
(18) Second wireless connection.

(20) Teeth.
(21) Spaces between teeth (20)
(22) Spaces in arches.
(23) Measurement parameter [or positional parameter that indicates the separation between grip extremities (2a)]
(24) Driving signal.
(25) Measurement or positional parameter signal.
(30) Computerized system or equipment.
(31) Screen or display of the computerized system (30).
(32) USB connection [in the system (30)].
(110) Sensor stage.
(120) Driving stage.
(130) Processing stage.
(140) Connection stage.
(200) Analogue transmission.
(201) Digital transmission.

### A BRIEF SUMMARY OF THE INVENTION

In general terms, the present invention is related to a device of computerized dental measurement comprising a measuring clamp (1) for teeth (20) and dental spaces (21), comprised by a set of mobile arms (2) ending in some exploration extremities (3), which exploring movement through the teeth (20) and dental spaces (21) determines the solidarity movement of the mobile arms (2). A transducer (11) turns the relative displacement movement between mobile arms (2), into signals (25) which express the positional parameters (23) determined by that movement, and, upon being connected to a computerized system (30), it transmits the signals (25) for their processing as measurement parameters (23). The transducer circuit (10), that may be analogue and/or digital, may have a manual driving means (12) in the measuring clamp (1). The invention is also related to a measuring method through which steps, the exploration extremities (3) are arranged on the teeth (20) or dental spaces (21), the measurement is performed and the sequence is repeated as many times as needed, until completing the measurement.

### DETAILED DESCRIPTION OF THE INVENTION

More particularly, the present device is intended to the measuring of teeth (20) and the different dental spaces (21), with a computerized management of said measurement.

This measuring device comprises a measuring clamp (1) comprising a set of mobile arms (2) related to each other by means of a mobile connection (4), which enables them to move one in relation to the other. In one embodiment, the mobile connection (4) is given by a rotary joint or connection.

Other possibilities have been considered, such as a linear mobile connection (4), for instance, rectilinear. In any case, the mobile connection (4) enables the operation of the measuring clamp (1).

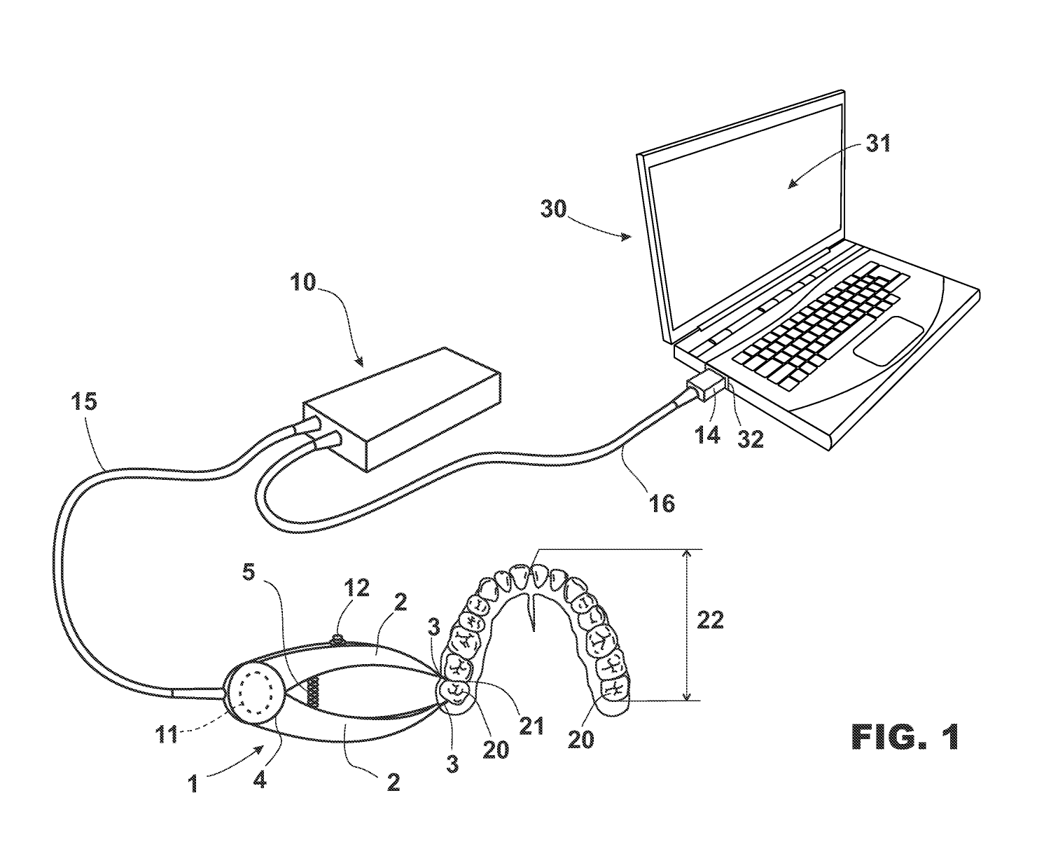

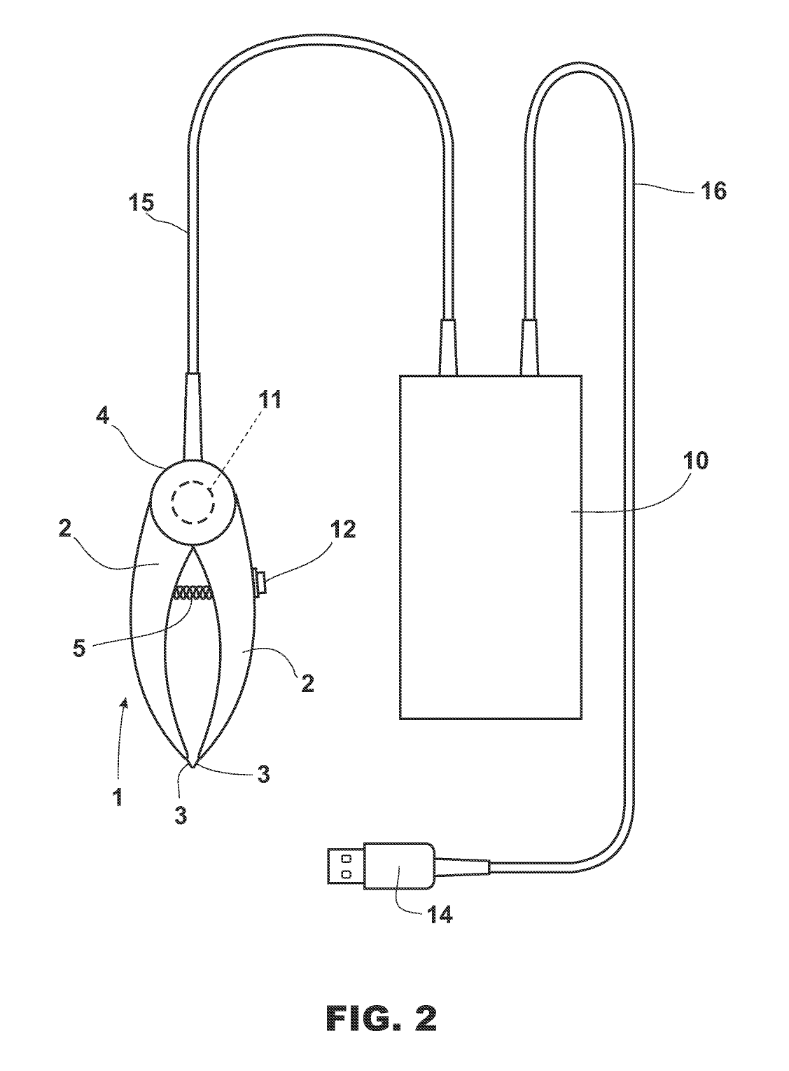

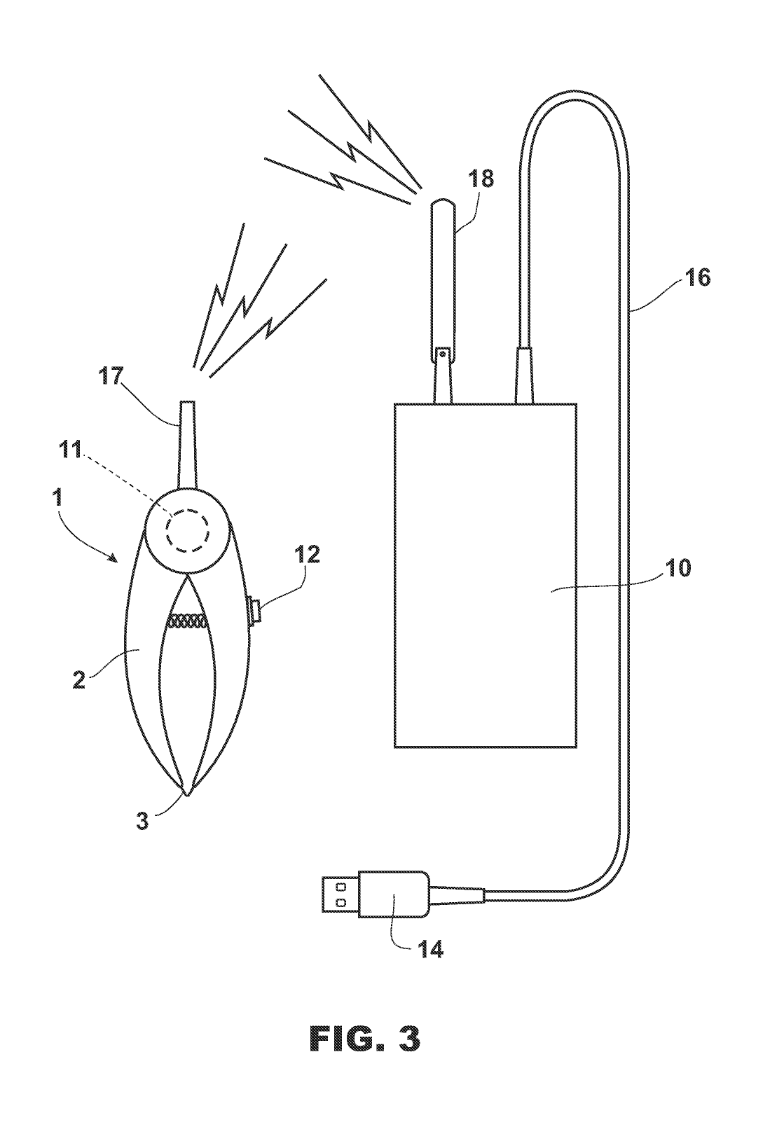

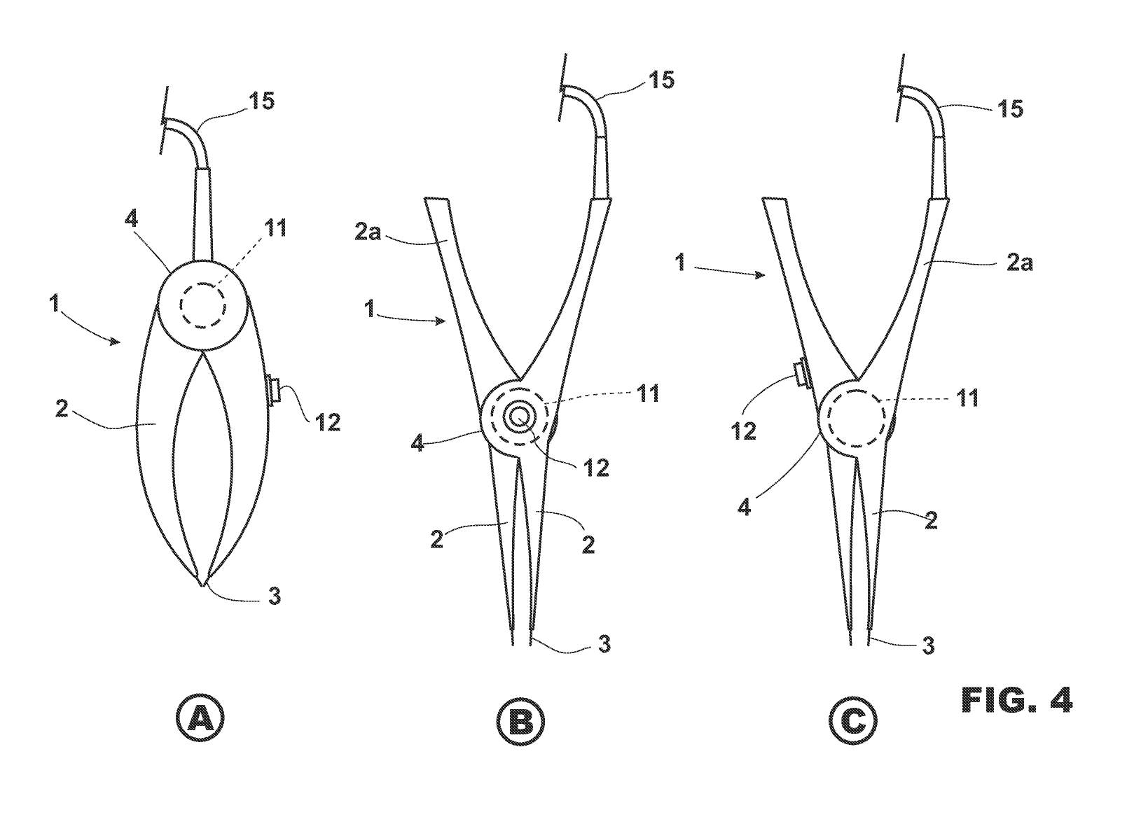

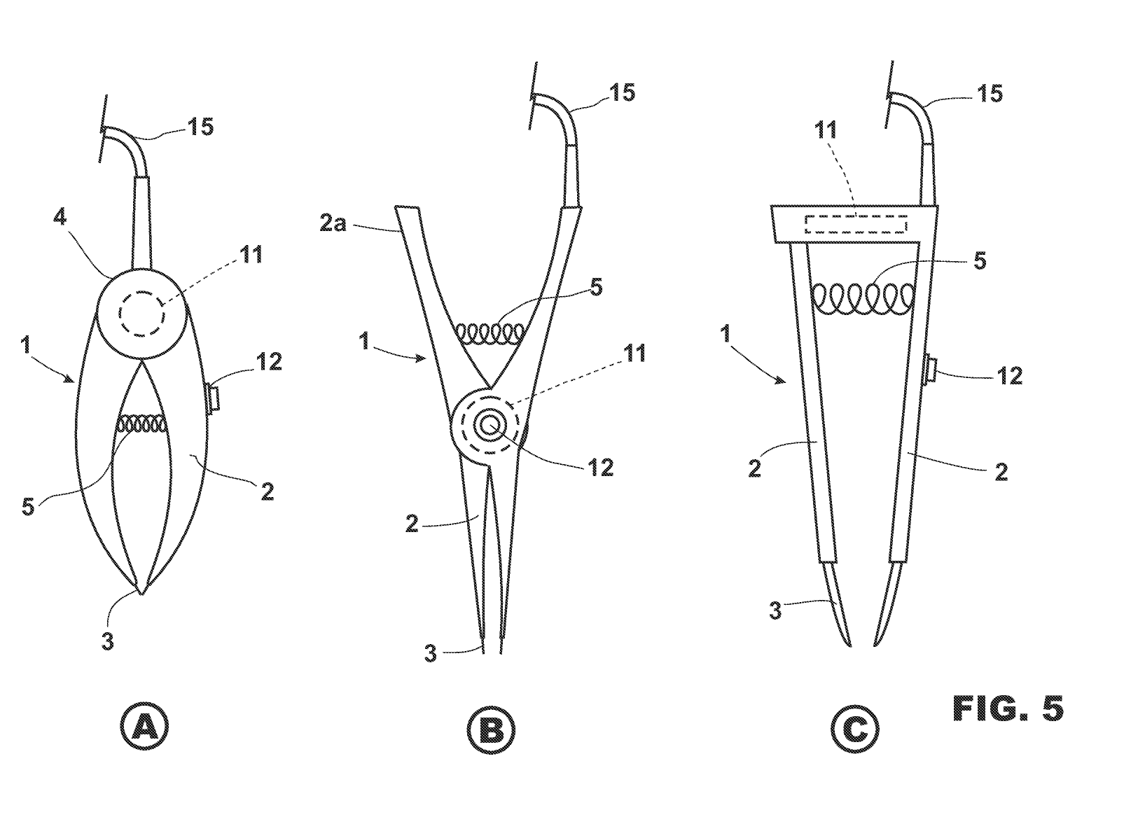

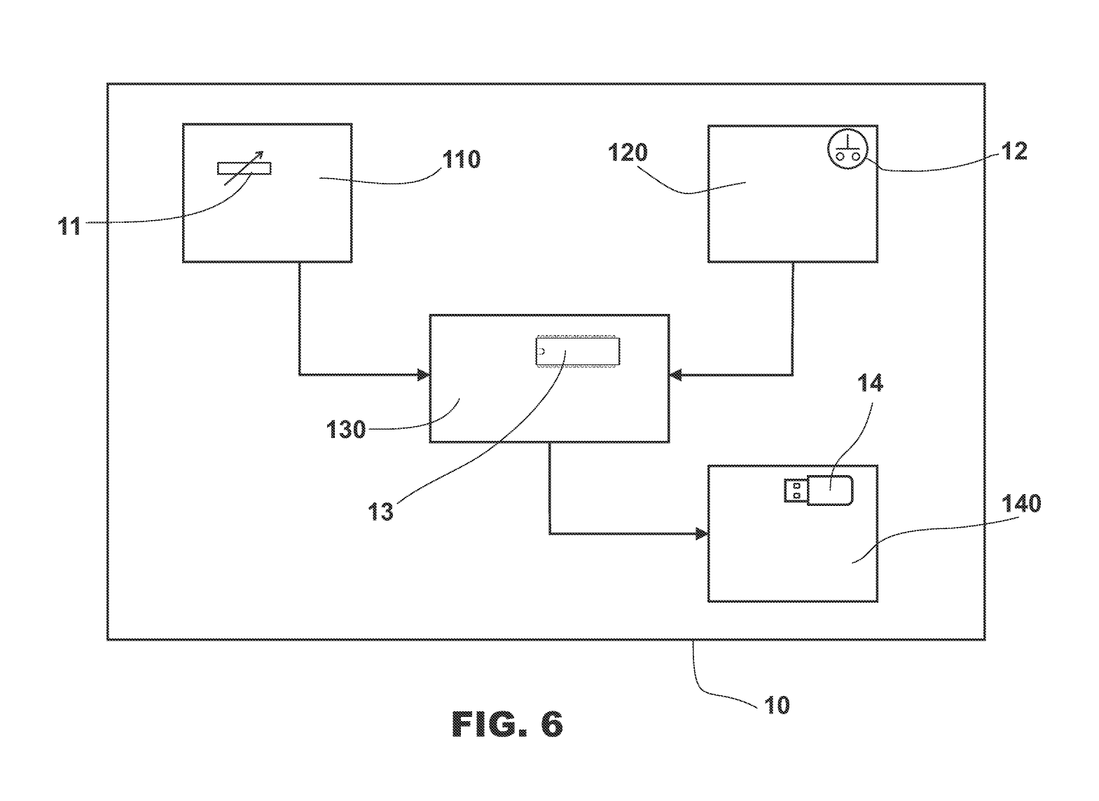

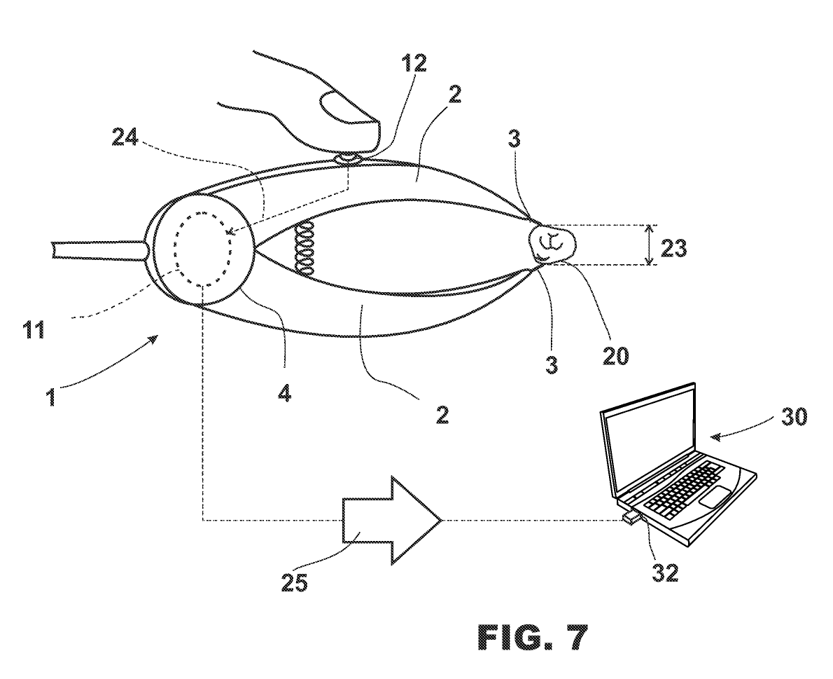

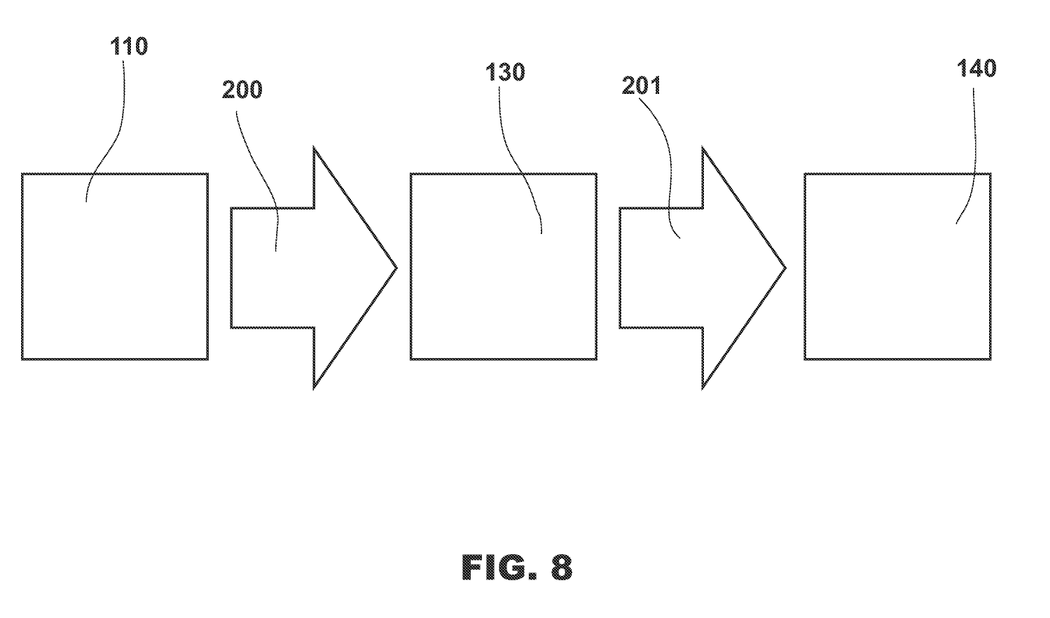

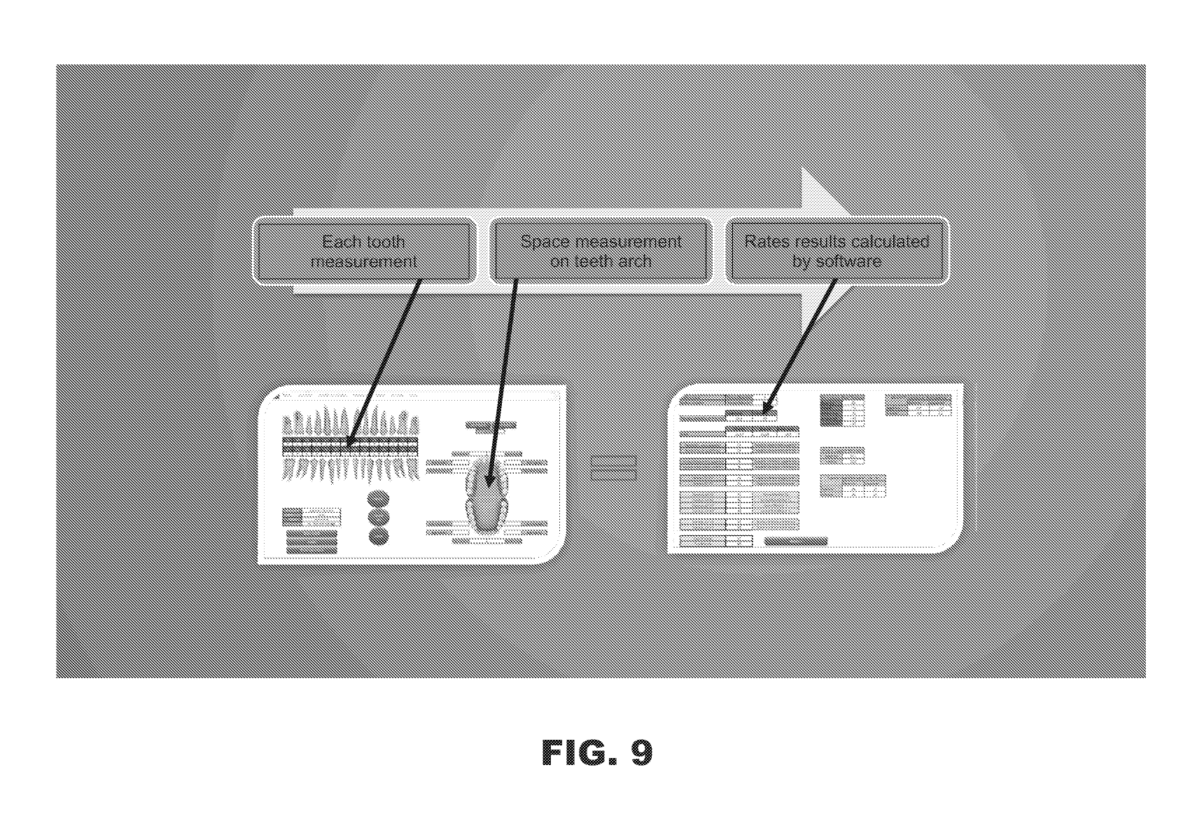

On the one hand, the mobile arms (2) may have the most varied shapes, although in all cases, they should end in exploration extremities (3) each. In their different variants, the mobile arms (2) may operate, for example, as class three levers [See FIG. 1, FIG. 4 drawing A and FIG. 5 drawing A] or as class one levers [See FIG. 4 drawings B-C and FIG. 5 drawing B]

Besides, said mobile arms (2) should enable a wide enough opening so that said exploration extremities (3) may position properly on the teeth (20) and dental spaces (21).

It has also been considered that the measuring clamp (1) be provided with an elastic means (5) which relates the mobile arms elastically (2). For example, in the case of FIG. 1, the elastic means (5) consists of a spring working upon compression, thus, its elastic influence keeps the measuring clamp (1) normally open. The same happens in the case of drawing B of FIG. 5, although in this last case, it might be used a spring operating upon traction between the resistance runs of said mobile arms (2).

On the other hand, the above mentioned mobile arms (2) end in some exploration extremities (3) prepared to slide in a convenient manner, over the surface of the teeth (20), and that, preferably, will have suitable sizes as to run the dental spaces (21) and interstices.

As the exploration extremities (3) are jointly related to the mobile arms (2), they determine the movement of the latter (2). These exploration extremities (3) may be detachable, so that interchangeable units of different type and specific for different applications may be available. It has also been provided the use of disposable exploration extremities (3), so that, once the measurement is completed, they are disposed.

This blends with the presence of a transducer (11) which turns the relative displacement movement between the mobile parts [mobile arms (2) and exploration extremities (3)], into signals (25) that match the positional parameters (23) determined by said movement.

The transducer (11) may be arranged at any part of the measuring clamp (1) that may result suitable to obtain the effect looked for [for example, within the mobile connection (4)].

This transducer (11) has connection means [for example a USB connector (14), wireless connection, etc.] that enables to connect it to a computerized system (30) and transmit the measuring signals (25) for their processing. The computerized system (30) may be any type of device able to perform the required processing, including computers, on their own or associated to local or remote data networks, by any means of communication.

Under the electronic viewpoint, the transducer (11) may be digital, analogue or mixed [with analogue parts and digital parts].

In an embodiment, the transducer (11) comprises a circuit which comprises a feeding stage, a sensor stage (110), a processing stage (130), a driving stage (120), and a connection stage (140).

The sensor stage (110) which is controlled by the movement of the mobile arms (2), delivers signals (25) of identification of the parameters (23) of movement of said arms (2). This stage (110) comprises a movement sensor (11) of the mobile arms (2) and the exploration extremities (3). Therefore, equally apt will result the resistive, capacitive, inductive, magnetic or hybrid elements [combinations of one or more from them], just by performing their function efficiently.

The processing stage (130) may comprise any type of microprocessor where the signals (25) of identification of the parameters (23) of movement of the mobile arms (2) enter, and data signals (25) apt to be processed by the computerized system (30) that receives them, are delivered .

The driving stage (120) controls the processing stage (130). It has been provided the possibility that it comprises a driving push-button (12) arranged on any of the mobile arms (2) of the measuring clamp (1). It might also depend on the computerized system (30) so that the driving is automatic, mixed, programmable, etc.

In a variant of this circuit (10), it may comprise an analogue part and another digital part. In this case, the analogue part may comprise the transmission of signals of the sensor stage (110) and the processing stage (130), whereas the digital part may comprise the transmission of signals between said processing stage (130) and the connection means (14) (17-18) with computerized systems (30).

### Operation

Once the measuring clamp (1) is conveniently positioned on the measurement field, the mobile arms (2) come closer to each other until the exploration extremities (3) place themselves on the tooth (20) or dental space (21) to measure.

In these conditions, the operator operates (24) the driving push-button (12) and moves the exploration extremities (3), until reaching the suitable position to make a new measurement and driving the driving push-button (12). In each case, the transducer sensor (11) turns the relative displacement movement between the mobile arms (2) and its exploration extremities (3), into signals (25) that express each positional parameters (23) determined by this movement. Therefore, each positional parameter (23) of relative displacement between said mobile arms (2), matches a specific and distinctive signal (25) used by the computerized system (30) to show the corresponding measuring parameter.

The above mentioned signals are transmitted to the computerized system (30) through the available connection means (14) (17-18).

### Method

A method of dental computerized measurement comprises a series of stages through which said measurement is performed.

In one embodiment, in a first step, it is confirmed the availability of the computerized system (30) to use, for which it is confirmed on its screen (31), the presence and status of the form fields to be completed with the measurement data obtained. Each form field represents a tooth (20) and/or dental space (21) and/or group.

Then, the measuring clamp is taken (1), the mobile arms are managed (2) and the exploration extremities (3) are positioned in the wanted places of the teeth (20) or spaces (21) to measure.

Once the exploration extremities (3) are positioned (23), the measurement is performed, either manually driving (24) the driving push-button (12) of the transducer circuit (10), or waiting until the computerized system (30) automatically obtains the measurement data coming from the signals (25) of said transducer (11).

Then, it is confirmed that the measurement data (25) has been entered to the computerized system (30), observing the form fields displayed on the computerized screen (31).

Then, the necessary steps are repeated, positioning (23) the exploration extremities (3) and making measurements on each scheduled tooth (20) or dental space (21), until the form fields that appear available sequentially are completed.

As an example:

With the device connected to a computer and with a suitable program, it is started to measure each of the teeth from the second upper right molar as far as the same molar on the left side, then, it is started to measure from the second lower right molar, ending at the second lower left molar.

In this way, it will have been obtained the measures of the mesiodistal widths of each tooth, together with the rates on which these values are based, such as, Bolton total index, Bolton's anterior, Tanaka-Johnston, Pont, etc.

At this moment, the program will indicate that the spaces should be measured, indicating on the computer screen, a graph that marks the portion of the arch that should be measured.

Once the measures of the spaces are obtained, the program will provide the result of the discrepancy bone-teeth index [upper, lower, anterior superior, anterior inferior and incisors] and the Moyers index.

Besides the results of the indexes already described, information will be obtained about different measures, such as: arch perimeter, spaces available to place teeth in the different sectors, addition of the different dental groups, space required, etc.

The present device enables to obtain several rates, following a simplified method, the program indicates in the computer, the distance that should be measured, and the operator only has to position the instrument and press the button. The estimated time taken by this method is extremely reduced and the operation is very efficient.

Undoubtedly, upon putting the present invention into practice, modifications may be introduced regarding certain construction details and form, without leaving the essential principles that are clearly explained in the claims below:

1. DEVICE OF COMPUTERIZED DENTAL MEASUREMENT, which is intended to measuring teeth and different dental spaces, with computerized management of said measurement, comprising:
Measuring instruments of said teeth,
Connection means to a computerized system able to process information, such as a computer, alone or associated to local or remote data networks, through any means of communication,
wherein it comprises:
A measuring clamp which comprises a set of mobile arms,
Said set of mobile arms ending in each exploration extremities prepared to recognize teeth and dental spaces, so that the exploring displacement of said extremities determines the joint displacement of said mobile arms,
At least one transducer which turns the relative displacement movement between the mobile parts of said measuring clamp, into signals that match the positional parameters determined by said relative displacement,
Connection means by which said measuring signals are transmitted to computerized systems prepared to process them; and
Record driving means of said positional parameters.

2. DEVICE OF COMPUTERIZED DENTAL MEASUREMENT, according to claim 1, wherein the transducer comprises, at least, an analogue part.

3. DEVICE OF COMPUTERIZED DENTAL MEASUREMENT, according to claim 1, wherein the transducer comprises, at least, a digital part.

4. DEVICE OF COMPUTERIZED DENTAL MEASUREMENT, according to claim 1, wherein the transducer comprises a displacement sensor of the exploration extremities, where the utilization of the signals matching said displacement is controlled by a driving means which comprises, at least, a push-button mounted on the measuring clamp.

5. DEVICE OF COMPUTERIZED DENTAL MEASUREMENT, according to claim 1, wherein the connection means comprises wireless means.

6. DEVICE OF COMPUTERIZED DENTAL MEASUREMENT, according to claim 1, wherein the connection means comprises a connection for USB ports.

7. DEVICE OF COMPUTERIZED DENTAL MEASUREMENT, according to claim 1, wherein the transducer comprises a circuit that, at least, comprises:
A feeding stage,
A sensor stage that, controlled by the movement of the mobile arms, delivers signals of identification of the parameters of movement of said arms,
A processing stage where said identification signals enter and from where computerized data signals exit,
A driving stage which controls said processing stage; and
A stage of connection to computerized systems.

8. DEVICE OF COMPUTERIZED DENTAL MEASUREMENT, according to claim 7, wherein the sensor stage comprises resistive elements.

9. DEVICE OF COMPUTERIZED DENTAL MEASUREMENT, according to claim 7, wherein the sensor stage comprises capacitive elements.

10. DEVICE OF COMPUTERIZED DENTAL MEASUREMENT, according to claim 7, wherein the sensor stage comprises inductive elements.

11. DEVICE OF COMPUTERIZED DENTAL MEASUREMENT, according to claim 7, wherein the sensor stage comprises magnetic elements.

12. DEVICE OF COMPUTERIZED DENTAL MEASUREMENT, according to claim 1, wherein the exploration extremities are disposable.

13. DEVICE OF COMPUTERIZED DENTAL MEASUREMENT, according to claim 1, wherein the exploration extremities are detachable.

14. DEVICE OF COMPUTERIZED DENTAL MEASUREMENT, according to claim 1, wherein the driving stage comprises, at least, a manual driving means.

15. DEVICE OF COMPUTERIZED DENTAL MEASUREMENT, according to claim 1, wherein the driving stage results to be controlled by the computerized system to which the transducer is connected.

16. DEVICE OF COMPUTERIZED DENTAL MEASUREMENT, according to claim 7, wherein the circuit comprises an analogue part and a digital part, wherein the analogue part comprises the transmission of signals between the sensor stage and the processing stage, whereas the digital part comprises the transmission of signals between said processing stage and the connection means with computerized systems.

17. MEASURING METHOD FOR THE DEVICE, wherein it comprises the following steps:
Positioning the exploration extremities on the teeth or dental spaces to measure,
Once said exploration extremities are positioned, performing the measurement; and
Repeating the steps to position said exploration extremities and performing measurements of each tooth or dental space to measure.

18. MEASURING METHOD, according to claim 17, wherein in the step of performing the measurement, it drives manually the driving means of the transducer circuit.

19. MEASURING METHOD, according to claim 17, wherein in the step of performing the measurement, it waits until de computerized system automatically obtains the measure data generated by the transducer.

20. MEASURING METHOD, according to claim 17, wherein it comprises the following steps:
Confirming the availability of the computerized system to use, checking on its screen, the form fields to complete with the measurement data obtained, representing each form field, a tooth and/or dental space,
Positioning the exploration extremities on the teeth or dental spaces to measure,
Once said exploration extremities are positioned, performing the measurement,
Confirming the measurement data had entered the computerized system, by means of the observation of the form fields displayed on said screen; and
Repeating the steps of positioning said exploration extremities, and performing measurements on each scheduled tooth or dental space, until completing the form fields which sequentially appear available.
